(19) United States
(12) Patent Application Publication
(10) Pub. No.: US 2018/0303719 A1
(43) Pub. Date: Oct. 25, 2018

(54) PILL DISPENSER SYSTEM

(71) Applicant: Judith Ann DeLury, Syracuse, IN (US)

(72) Inventor: Judith Ann DeLury, Syracuse, IN (US)

(21) Appl. No.: 15/709,469

(22) Filed: Sep. 19, 2017

Related U.S. Application Data
(60) Provisional application No. 62/488,044, filed on Apr. 20, 2017.

(51) Int. Cl. A61J 7/00; A61J 7/04; G06F 19/00; A61J 1/03

(52) U.S. Cl. CPC A61J 7/0084; A61J 7/0481; G06F 19/3462; G06Q 10/087; A61J 2205/60; A61J 2200/30; A61J 1/03

(57) ABSTRACT

A pill dispenser system; the device is lockable and able to hold and dispense premanufactured roll(s) of medication with pouches linked together in a continuous strip. The premanufactured roll of medication pouches is manufactured according to a prescribed dosage schedule. The pill dispenser system includes a combination of dispenser assembly including a housing having a first-member, and a second-member, computer components, a premanufactured roll of medication, an adjustable holder, a roll advancing mechanism, a separator, a securer, a power source, a user-interface, at least one locking mechanism, at least one sensor, and a code reader providing a safe and convenient way for patients and caregivers to manage medication-dosing schedules.

### CROSS REFERENCE TO RELATED APPLICATION

The present application is related to and claims priority to U.S. Provisional Patent Application No. 62/488,044 filed Apr. 20, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### FIELD OF THE INVENTION

The present invention relates generally to the field of medication dispensers and more specifically relates to a lockable pill dispenser.

### DESCRIPTION OF RELATED ART

Many people take medication on a regular basis to maintain control over certain diseases such as diabetes, high cholesterol, high blood pressure, pain medication, water intake and other liquid medications. Timing and regularity are critical to manage these diseases, and maintain the effectiveness of the medication. For example, some diabetes medicine must be taken in exactly twelve hour intervals to maintain the proper blood sugar level. It can be difficult for patients, especially those who take several different medications and those who suffer from memory loss, as well as caregivers who manage multiple patients' complex dosing schedules, to take the correct medication at the correct times. Unfortunately, incorrect dosages may not only reduce the medication's effectiveness but it may also compromise the patient's overall health. Additionally, whether inadvertently or purposely, people may take medication that doesn't belong to them, which can be dangerous and life threatening. An effective alternative is needed.

U.S. Pub. No. 2010/0100237 to Nitesh Ratnakar relates to a smart medicine container. The described smart medicine container includes a dispenser having means to dispense desired number of pills from a bulk supply of pills contained in the dispenser. The dispenser comprises of storage compartment having bulk supply of pills and having a discharge port emptying into counting compartment. The counting compartment contains first and second conveyors moving at first and second speed; wherein the second speed is greater than the first speed thereby enabling pill separation; the second conveyor discharges pills into dispensing compartment. Sensors are strategically placed along the conveyors to count pills discharged into dispensing compartment. A pill recovery system and apparatus is disposed inside the dispenser having means to recover pills remaining on conveyors upon completion of a dispensation cycle and deposit recovered pills back into the storage compartment for use in future dispensation cycles. A docking station having receptacles to accommodate dispenser is provided. Docking station has communication ports enabling two- way communication with personal computer. The dispenser has multiple security features including locking mechanisms at inlet and outlet; and internal circuitry that is responsive to the ‘disable’ electronic signal originating from dispenser's internal clock and remote server in communication link with the dispenser.

### BRIEF SUMMARY OF THE INVENTION

In view of the foregoing disadvantages inherent in the known medication dispensing means art, the present disclosure provides a novel pill dispenser system. The general purpose of the present disclosure, which will be described subsequently in greater detail, is to provide a safe and convenient means for patients and caregivers to manage medication-dosing schedules.

A pill dispenser system is disclosed herein. The pill dispenser system includes a dispenser assembly including a housing having multiple members including a first-member, and a second-member, a memory, a processor, a driver, a premanufactured roll of medication, an adjustable holder, a roll advancing mechanism, a separator, a securer, a power source, a user-interface, at least one locking mechanism, at least one sensor, and a code reader. The housing is configured to ‘house’ computer components including a memory, a processor, a driver, the premanufactured roll of medication supported on an adjustable holder, the power source, and the adjustable holder within an inner volume of the housing. The housing is configured to open and close the housing as to insert the premanufactured roll of medication and access the inner volume. The first-member and the second-member hingedly coupled to one another via a hinging mechanism allowing the opening and closing of the housing for access to internal components.

The user-interface may include a display screen, a key pad, and at least one port such as a USB-port. The at least one locking mechanism in communication with the at least one sensor. The at least one locking mechanism provides security and locks the pill dispenser system and restricts unauthorized access and dispenses the separate individual packages at designated programmed times. The device provides a safe and convenient way for patients and caregivers to manage medication-dosing schedules.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, pill dispenser system, constructed and operative according to the teachings of the present disclosure.

FIG. 1 is a front perspective view of the pill dispenser system during an ‘in-use’ condition, according to an embodiment of the disclosure.

FIG. 2 is a perspective view of the pill dispenser system of FIG. 1, according to an embodiment of the present disclosure.

FIG. 3 is a perspective view of the pill dispenser system of FIG. 1, according to an embodiment of the present disclosure.

FIG. 4 is a perspective view of the pill dispenser system of FIG. 1, according to an embodiment of the present disclosure.

FIG. 5 is a perspective view of the pill dispenser system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to medication dispensers and more particularly to a pill dispenser system as used to improve the locking programmable pill dispenser.

Generally, the present invention reduces medication-dosing errors, which can compound ailments and inhibit health. It dispenses prescribed dosages at specified times throughout the day. It prevents unauthorized individuals from accessing medication, whether on purpose or accident. It saves patients and caregivers a considerable amount of time and frustration dealing with complex dosing schedules. The present invention avoids medication mix-ups among people in the same household. Locking programmable pill dispenser provides a safe and convenient way for patients and caregivers to manage medication-dosing schedules. This innovative product may comprise a device that accepts, stores, and holds a pre-manufactured roll of medication. A mechanism can advance the roll of medication one packet at a time; each packet can be clearly labeled and coded with the time of day its content should be consumed. A sensor and code reader can recognize the information and dispense the packet at the appropriate time. An alarm can sound when the medication is dispensed.

Additionally, the device may include a lock with a fingerprint scanner, camera, and security code to retrieve the dispensed medication. Further, the device can have a touch screen, buttons and/or keypad for programming personalized settings, on/off switch, speakers, and AC adaptor and backup power source. A latching mechanism is included to secure the lid to the rest of the housing. There is also a movable cutting edge that will close the gap needed for the pre-manufactured roll of medications to be dispensed through. The device can also be outfitted with open-network technology and wireless technology, and can allow for the customization of the display, reminders, alarm sounds, time zones, and more.

The present invention assists individuals who are unable to properly keep track of medication(s) for a variety of reasons. The pill dispenser system prevents setting up pill reminders incorrectly. Examples include, but are not limited to: omitting medication(s) and/or placing the wrong medication in the wrong compartment. The device helps eliminate worries associated with confusing medication(s), such as between individuals where multiple individuals in the same household are taking medication(s) or when old medication(s) prescriptions are replaced with new ones, and prevents unauthorized access to medication(s) including, but not limited to, young children, individuals with dementia or other mental challenges. The device also helps determine who the perpetrator(s) of unauthorized access to medication(s) was/were whether by accident or on purpose.

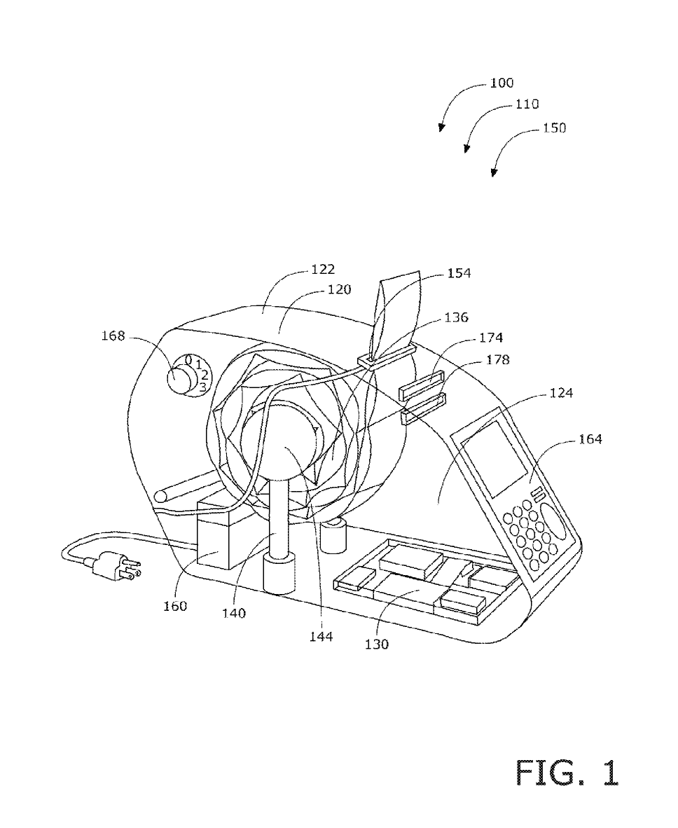

Referring now more specifically to the drawings by numerals of reference, there is shown in FIGS. 1-4, various views of a pill dispenser system 100. FIG. 1 shows the pill dispenser system 100 during an ‘in-use’ condition 150, according to an embodiment of the present disclosure. As illustrated, the pill dispenser system 100 may include a dispenser assembly 110 including a housing 120 having a first-member 122, and a second-member 124, computer components 130 including at least a memory, a processor, a driver (necessary computing means), a pre-manufactured roll of medication 136, an adjustable holder 140, a roll advancing mechanism 144, a separator, a securer, a power source 160, a user-interface 164, at least one locking mechanism 168, at least one sensor 174, and a code reader 178.

The housing 120 is configured to house the memory, the processor, the driver, the premanufactured roll of medication 136 supported on an adjustable holder 140, the power source 160, and the adjustable holder 140 within an inner volume of the housing 120. The housing 120 is configured to open and close so as to insert the premanufactured roll of medication 136 and access the inner volume. The first-member 122 and the second-member 124 hingedly coupled to one another via a hinging mechanism allowing the opening and closing of the housing 120 for access to internal components. The memory, the processor, the driver may include a memory, a processor, and a driver (other computing components may be used). The user-interface 164 is positioned on an outer surface of the housing 120 for use. The user-interface 164 comprises a display screen, a key pad, and at least one port such as a USB-port. The display screen may be touch screen or non-touch screen. The power source 160 further may include a back-up power source. The power source 160 in a preferred embodiment, includes a power cord and a power supply adaptor.

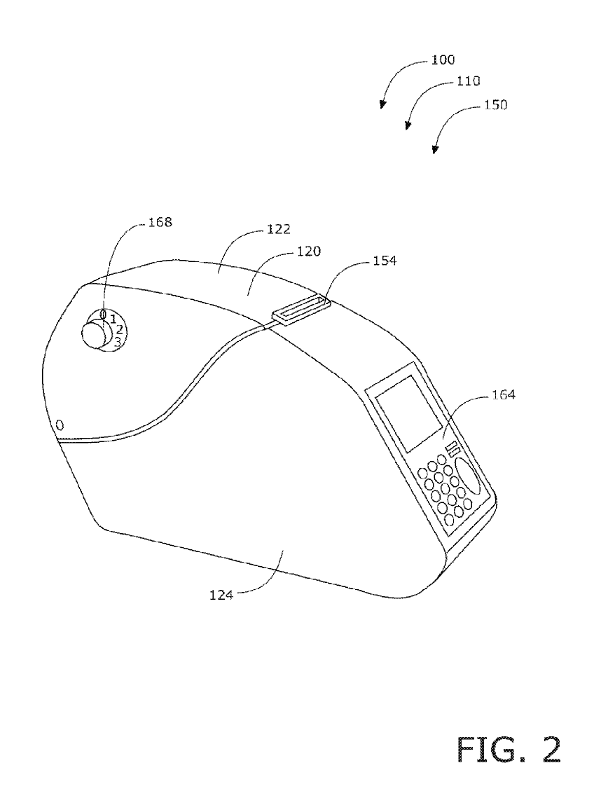

FIG. 2 shows a perspective view of the pill dispenser system 100 of FIG. 1, according to an embodiment of the present disclosure. As above, the pill dispenser system 100 may include a dispenser assembly 110 including the housing 120, the memory, the processor, the driver, the premanufactured roll of medication 136, the adjustable holder 140, the roll advancing mechanism 144, the separator, the securer, the power source 160, the user- interface 164, at least one locking mechanism 168, at least one sensor 174, and a code reader 178. The roll advancing mechanism 144 is configured to advance the premanufactured roll of medication 136 through an opening 154. The premanufactured roll of medication(s) 136 includes pouches linked together in a continuous strip. The separator is positioned at the opening 154 and is configured to separate the premanufactured roll of medication 136 into separate individual packages. The securer is configured to secure remaining premanufactured roll of medication 136 once one of the separate individual packages preventing unauthorized access. The separator and securer may be separate or combined into one device.

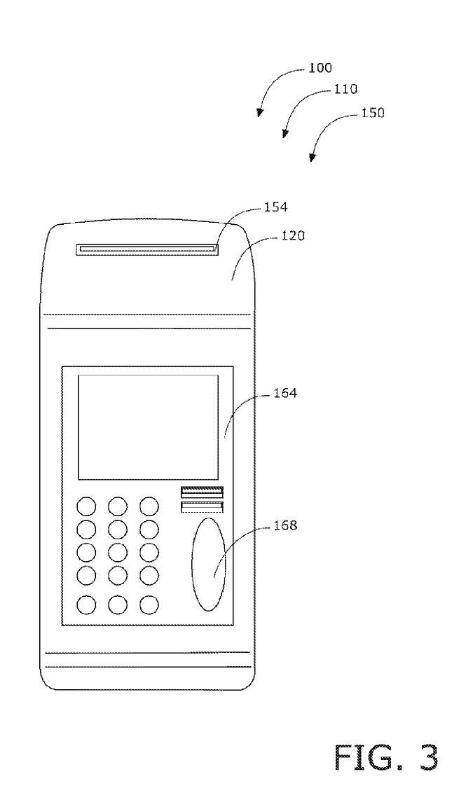

FIG. 3 shows a perspective view of the pill dispenser system 100 of FIG. 1, according to an embodiment of the present disclosure. As above, the pill dispenser system 100 may include at least one locking mechanism 168, at least one sensor 174, and the code reader 178. The at least one locking mechanism 168 in communication with the at least one sensor 174. The at least one sensor 174 is configured to detect a position of the premanufactured roll of medication 136 as to properly advance the premanufactured roll of medication 136 through the opening 154. The at least one sensor 174 comprises said code reader 178. The code reader 178 is configured to read a printed code on the separate individual packages such as, but not limited to a bar code or a QR code to include future code types. The at least one sensor 174 may further comprise a position sensor and a motion sensor. In certain embodiments, the present invention may include at least one camera and speakers.

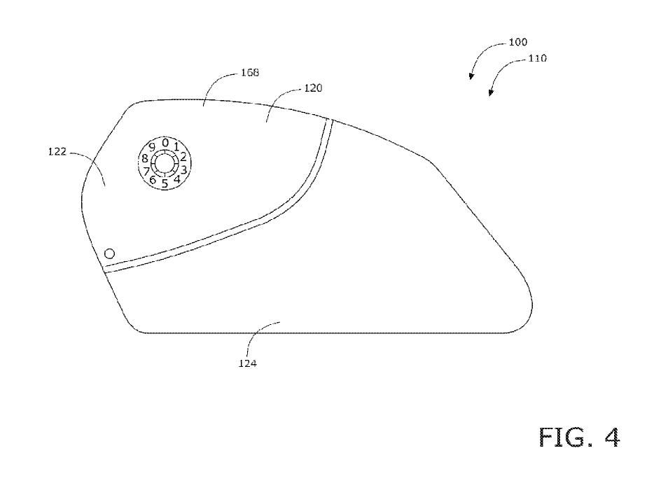

FIG. 4 shows a perspective view of the pill dispenser system 100 of FIG. 1, according to an embodiment of the present disclosure. As above, the pill dispenser system 100 may include the dispenser assembly 110. The power source 160 provides power to the dispenser assembly 110 and a lighting mechanism. The at least one locking mechanism 168 provides security and locks the pill dispenser system 100 and restricts unauthorized access while dispensing the separate individual packages at designated programmed times. The at least one locking mechanism 168 may include a conventional lock, a combination lock, and at least one locking mechanism 168 which requires computer input such as a fingerprint reader, retinal scanner, a passcode, facial recognition, voice recognition or other suitable locking means.

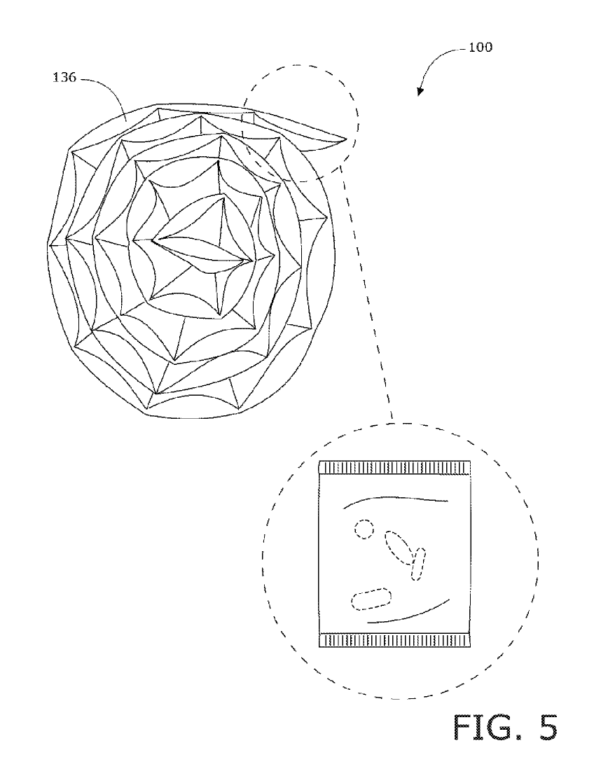

Referring now to FIG. 5 showing a perspective view of the pill dispenser system 100 of FIG. 1, according to an embodiment of the present disclosure. As above, the pill dispenser system 100 may be configured to connect to at least one mobile device as means for user interface and remote access via a mobile application in communication with software of the pill dispenser system 100. The pill dispenser system 100 may further include BLUETOOTH and wireless internet connectivity.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pill dispenser system comprising:
a dispenser assembly including;
a housing having;
a first-member; and
a second-member;
a memory;
a processor;
a driver;
a premanufactured roll of medication;
an adjustable holder;
a roll advancing mechanism;
a separator;
a securer;
a power source;
an adjustable holder;
a user-interface;
at least one locking mechanism;
at least one sensor; and
a code reader;
wherein said housing is configured to house said memory, said processor, said driver, said premanufactured roll of medication supported on an adjustable holder, said power source, and said adjustable holder within an inner volume of said housing;
wherein said housing is configured to open and close as to insert said premanufactured roll of medication and access said inner volume;
wherein said first-member and said second-member hingedly coupled to one another via a hinging mechanism;
wherein said roll advancing mechanism is configured to advance said premanufactured roll of medication through an opening;
wherein said separator is positioned at said opening and is configured to separate said premanufactured roll of medication in to separate individual packages;
wherein said securer is configured to secure remaining said premanufactured roll of medication once one of said separate individual packages preventing unauthorized access;
wherein said at least one locking mechanism in communication with said at least one sensor;
wherein said code reader is configured to read a printed code on said separate individual packages;
wherein said at least one sensor is configured to detect a position of said premanufactured roll of medication as to properly advance said premanufactured roll of medication through said opening;
wherein said power source provides power to said dispenser assembly; and
wherein said at least one locking mechanism provides security and locks said pill dispenser system and restricts unauthorized access and dispenses said separate individual packages at designated programmed times.

2. The pill dispenser system of claim 1, wherein said power source comprises DC current and alternately uses AC current.

3. The pill dispenser system of claim 1, wherein said user-interface is positioned on an outer surface of said housing for use.

4. The pill dispenser system of claim 1, wherein said user-interface comprises a display screen, a key pad, and at least one port.

5. The pill dispenser system of claim 4, wherein said at least one port comprises a USB-port.

6. The pill dispenser system of claim 1, wherein said power source further comprises a back-up said power source.

7. The pill dispenser system of claim 6, wherein said power source comprises a power cord.

8. The pill dispenser system of claim 1, further comprises at least one camera.

9. The pill dispenser system of claim 1, wherein said display screen is touch screen.

10. The pill dispenser system of claim 1, further comprises a power supply adaptor.

11. The pill dispenser system of claim 10, further comprises speakers.

12. The pill dispenser system of claim 1, wherein said pill dispenser system is configured to connect to at least one mobile device as means for user interface and remote access.

13. The pill dispenser system of claim 1, wherein said at least one locking mechanism comprises a combination lock.

14. The pill dispenser system of claim 1, wherein said at least one locking mechanism comprises a fingerprint reader.

15. The pill dispenser system of claim 1, wherein said at least one locking mechanism comprises a combination lock.

16. The pill dispenser system of claim 1, wherein said at least one locking mechanism comprises a conventional lock.

17. The pill dispenser system of claim 1, wherein said at least one sensor comprises said code reader.

18. The pill dispenser system of claim 1, wherein said at least one sensor comprises a position sensor.

19. The pill dispenser system of claim 1, wherein said at least one sensor comprises a motion sensor.

20. A pill dispenser system comprising:
a dispenser assembly including;
a housing having;
a first-member; and
a second-member;
a memory;
a processor;
a driver;
a premanufactured roll of medication;
an adjustable holder;
a roll advancing mechanism;
a separator;
a securer;
a power source;
a power supply adaptor;
speakers;
an adjustable holder;
a user-interface;
at least one locking mechanism;
at least one camera;
at least one sensor; and
a code reader;
wherein said housing is configured to house said memory, said processor, said driver, said premanufactured roll of medication supported on an adjustable holder, said power source, and said adjustable holder within an inner volume of said housing;
wherein said computer components comprise a memory, a processor, and a driver;
wherein said user-interface is positioned on an outer surface of said housing for use;
wherein said user-interface comprises a display screen, a key pad, and at least one port;
wherein said at least one port comprises a USB-port;
wherein said housing is configured to open and close as to insert said premanufactured roll of medication and access said inner volume;
wherein said first-member and said second-member hingedly coupled to one another via a hinging mechanism;
wherein said roll advancing mechanism is configured to advance said premanufactured roll of medication through an opening;
wherein said separator is positioned at said opening and is configured to separate said premanufactured roll of medication in to separate individual packages;
wherein said securer is configured to secure remaining said premanufactured roll of medication once one of said separate individual packages preventing unauthorized access;
wherein said at least one locking mechanism in communication with said at least one sensor;
wherein said code reader is configured to read a printed code on said separate individual packages;
wherein said at least one sensor is configured to detect a position of said premanufactured roll of medication as to properly advance said premanufactured roll of medication through said opening;
wherein said power source provides power to said dispenser assembly;
wherein said power source further comprises a back-up said power source;
wherein said power source comprises a power cord;
wherein said pill dispenser system is configured to connect to at least one mobile device as means for user interface and remote access;
wherein said at least one locking mechanism provides security and locks said pill dispenser system and restricts unauthorized access and dispenses said separate individual packages at designated programmed times; and
wherein said at least one locking mechanism comprises a combination of a manual input and computer input.
